(19) United States
(12) Patent Application Publication
(10) Pub. No.: US 2012/0234404 A1
(43) Pub. Date: Sep. 20, 2012

(54) Leak Identifier for Insulated Valve Jackets

(76) Inventor: Ryan P. Hughes, Sarnia (CA)

(21) Appl. No.: 13/050,107

(22) Filed: Mar. 17, 2011

(51) Int. Cl. F16K 51/00

(52) U.S. Cl. 137/375

(57) ABSTRACT

There is disclosed an improved insulated valve jacket for placement around a valve. The valve jacket includes an insulated wall having an inner surface and an outer surface, the inner surface facing the valve. The insulated wall has a passage passing through the insulated wall from the inner surface to the outer surface. The improved jacket also includes a conduit having opposite first and second ends, a first flange formed on the first end of the conduit and a second flange positioned adjacent the second end of the conduit. The conduit is positioned in the passage with the insulated wall positioned between the first and second flanges. A clear tube extends from the second end of the conduit such that the clear tube is positioned outside of the jacket.

### FIELD OF THE INVENTION

The invention relates generally to insulated jackets for large valves.

### BACKGROUND OF THE INVENTION

Large valves used in pipe lines which are exposed out doors are often covered with an insulated jacket in order to maintain the operation of the valves during extremely cold conditions. This is particularly the case in the oil and gas industries where pipes carrying high pressure gas to and from processing equipment are often exposed to freezing cold temperatures. Insulated jackets which are shaped to fit around these valves are often used to prevent the valves from freezing. While these jackets are effective in maintaining the operation of the valves, they make inspecting the valves for leaks much more difficult as the jackets cover over the valves. This requires the valve jackets to be removed in order to visually inspect the valve. A need therefore exists for an improved valve jacket which facilitates the inspecting the valve.

### SUMMARY OF THE INVENTION

In accordance with one aspect of the present invention, there is provided an improved insulated valve jacket for placement around a valve. The valve jacket includes an insulated wall having an inner surface and an outer surface, the inner surface facing the valve. The insulated wall has a passage passing through the insulated wall from the inner surface to the outer surface. The improved jacket also includes a conduit having opposite first and second ends, a first flange formed on the first end of the conduit and a second flange positioned adjacent the second end of the conduit. The conduit is positioned in the passage with the insulated wall positioned between the first and second flanges. A clear tube extends from the second end of the conduit such that the clear tube is positioned outside of the jacket.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a cross sectional view of a portion of a valve jacket made in accordance with the present invention showing the leak identifier.

FIG. 2 is an expanded view of portion A of FIG. 1.

In the drawings like characters of reference indicate corresponding parts in the different figures.

### DETAILED DESCRIPTION OF THE INVENTION

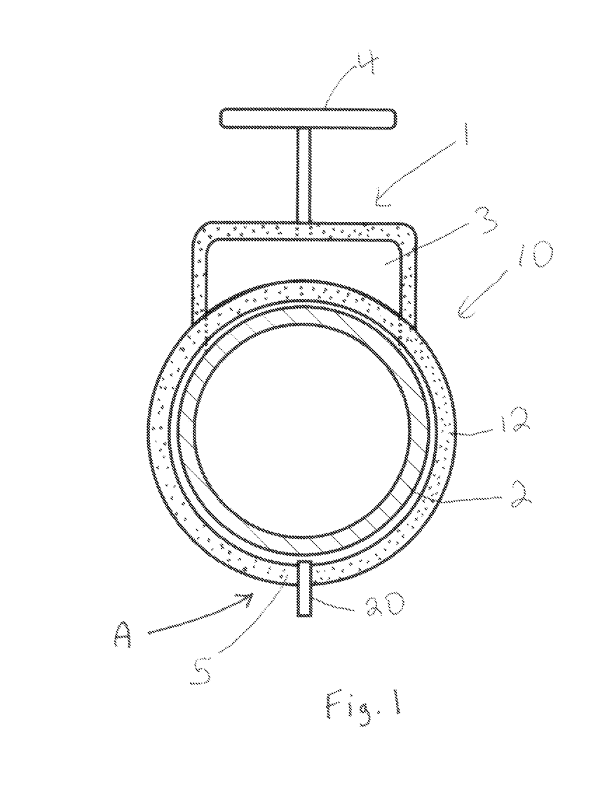

Referring to FIG. 1, a valve jacket made in accordance with the present invention is shown generally as item 10 and includes an insulating wall 12 which covers over valve 1. Valve 1 has pipe portion 2 and closure mechanism 3 coupled to valve handle 4. Insulating wall 12 is preferably formed to blanket over pipe portion 2 as well as closure mechanism 3 leaving handle portion 4 exposed. Conduit 20 is formed at a low gravity position 5 below valve 1.

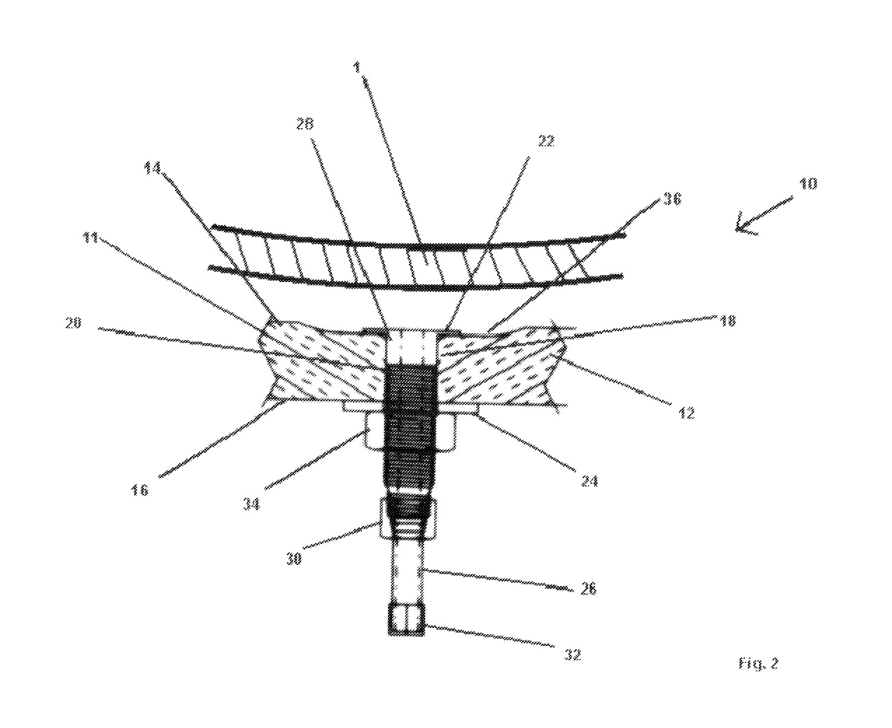

Referring to FIG. 2, conduit 20 is positioned right below valve 1 and has opposite ends 28 and 30, inner flange 22 formed on end 28, flange 24 positioned adjacent end 30, clear tube 26 extending from end 30 and passage 18 through which conduit 20 passes. Retaining nut 34 is threaded onto end 30 of conduit 20 to keep flange 24 tight against outer surface 16 of insulated wall 12. The end of clear tube 26 is closed off by removable cap 32.

Insulated wall 12 is made of a flexible insulation layer 11 sandwiched between inner fabric layer 14 and outer fabric layer 16. Insulation layer 11 can be any suitable material such as fiberglass insulation, ceramic or cellulose fiber fill or the like. Fabric layers 14 and 16 can also be any suitable durable material such as nylon. Suitable finished sheets of flexible insulation which is ready made are available in the market which can be used to make insulated wall 12.

Inner flange 22 has a diameter which is smaller than the diameter of outer flange 24. The difference in the sizes of the two flanges ensures that when the two flanges are biased towards each other with sufficient force by threading retaining nut 34 tightly onto end 30, dimple 36 will form on inner surface 14 of insulated wall 12 surrounding inner flange 22. The formation of the dimple serves two purposes. Firstly, it provides a visual indication that the flanges are tightly sealed onto the insulated wall so as to avoid the possibility of liquid leaking past the inner flange. Also, the dimple establishes a lowest gravitational point effectively funneling any leaked liquid towards conduit 20 to ensure that the liquid passes through the conduit and into clear tube 26. This has the effect of ensuring that even a small leak of liquid will end up being visible in clear tube 26.

Clear tube 26 may consist of a clear plastic tube, a glass tube, or depending on the conditions the valve jacket is likely to experience, the clear tube may even be made of quartz. Clear tube 26 acts as a means of quickly inspecting the valve underneath the insulated jacket. In the event the valve should develop a slow leak, liquid will accumulate in clear tube 26 where it can be observed. Chemical reagents may be added into clear tube 26 to emphasis the presence of a leak. For example, a granulated chemical indicator could be packed into clear tube 26 which chemically reacts to change color when in the presence of any liquid (or gas) which leaks from the valve and passes into the tube. This allows for the quick visual inspection of whether the valve is leaking without requiring the valve jacket to be removed. In addition, cap 32 may be removed in order to insert a chemical probe to test any gas contained within the valve jacket. In the event the valve is slowly leaking gas, a chemical probe inserted into tube 26 may indicate the presence of the leak. In such cases, the presence of the valve jacket actually increases the accuracy of the leak test because it effectively funnels the liquid or gas into tube 26 where it can more easily be observed or detected. Preferably, conduit 20 is positioned on the valve jacket at a position on the jacket corresponding to the lowest gravitational point on the valve covered by the jacket. The lowest gravitational point on the jacket will generally be that part of the jacket which is immediately below the valve. This ensures that any liquid leaking from the valve will be trapped in tube 26 where it can be observed.

If the valve jacket is to be used to cover valves having a very high operating temperature, then it is preferable to coat inner flange 22 with a highly heat reflective coating to lessen the amount of heat being transferred to tube 26. If the valve jacket is used to cover valves which will operate at very high temperatures, then it is possible that heat may be transferred from the valve to conduit 20 which in turn may pass heat to tube 26 causing possible damage to tube 26. By applying a heat reflecting coating to inner flange 22, the flange will reflect much of the heat thereby resulting in less heat transfer to conduit 20. Suitable ceramic spray-welded coating methods are commercially available which can be used to deposit a highly durable heat reflective ceramic coating onto inner flange 22.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. An insulated valve jacket for placement around a valve, the valve jacket comprising:
a. An insulated wall having an inner surface and an outer surface, the inner surface facing the valve, the insulated wall having a passage passing there through from the inner surface to the outer surface;
b. A conduit having opposite first and second ends, a first flange formed on the first end of the conduit and a second flange positioned adjacent the second end of the conduit;
c. The conduit being positioned in the passage with the insulated wall positioned between the first and second flanges;
d. A clear tube extending from the second end of the conduit such that the clear tube is positioned outside of the jacket.

2. The insulated valve jacket of claim 1 wherein the second end of the conduit is threaded and wherein the second flange is in the form of a washer, a retainer nut being threaded onto the second end of the conduit to position the washer against the outer surface of the insulated wall of the jacket.

3. The insulated valve jacket of claim 1 wherein the second flange is wider than the first flange and wherein the first and second flanges are biased towards each other such that a portion of the insulated wall between the first and second flanges is compressed to form a dimple surrounding the first flange.

4. The insulated valve jacket of claim 3 wherein the second end of the conduit is threaded and wherein the second flange is in the form of a washer, a retainer nut being threaded onto the second end of the conduit with the washer positioned between the retainer nut and the outer surface of the insulated wall, the retainer nut being threaded onto the second end of the conduit sufficiently to bias the second washer to the first washer so as to form the dimple.

5. The insulated valve jacket of claim 4 wherein the conduit is positioned on a bottom portion of the jacket so as to place the conduit at a point below the valve at a lowest gravitational point on the jacket.

6. The insulated valve jacket of claim 5 further comprising a removable cap mounted to clear tube at an end of the clear tube opposite the insulated wall.

7. The insulated valve jacket of claim 6 wherein the first flange is coated with a heat reflecting coating.

8. The insulated valve jacket of claim 7 wherein the heat reflecting coating comprises a spray welded ceramic coating.
